(19) United States
(12) Patent Application Publication
(10) Pub. No.: US 2026/0366337 A1
(43) Pub. Date: Nov. 19, 2026

(54) DOOR LATCH

(71) Applicant: ILLINOIS TOOL WORKS INC., GLENVIEW, IL (US)

(72) Inventor: Yang WANG, Dongguan City (CN)

(73) Assignee: ILLINOIS TOOL WORKS INC., GLENVIEW, IL (US)

(21) Appl. No.: 19/675,765

(22) Filed: May 13, 2026

(30) Foreign Application Priority Data
May 15, 2025 (CN) 202510629208.8

(51) Int. Cl. E05B 65/00

(52) U.S. Cl. CPC E05B 65/00

(57) ABSTRACT

A door lock includes a door lock box with a top cover provided with a door lock hole for inserting a door hook. A cam is arranged in the door lock box for catching the door hook. A slider is located within the door lock box and slidable in an axial vertical direction between a locked position and an unlocked position. A switch box is arranged at a rear portion of the door lock box and includes an actuating latch for controlling a locking state of the slider. A sensing rocker includes a forming part for interacting with the slider. A push rod is positioned in the switch box for controlling the on-off of a door sensing circuit, wherein the sliding of the slider causes the sensing rocker to rotate which causes the push rod to be switched between the first position and the second position.

### CROSS-REFERENCE TO RELATED APPLICATION

Chinese Patent Application No. CN 202510629208.8, filed on 15 May 2025, the priority document corresponding to this invention, to which a foreign priority benefit is claimed to under Title 35, United States Code, Section 119, and their entire teachings are incorporated, by reference, into this specification.

### BACKGROUND OF THE INVENTION

### Field of the Invention

The present invention relates to a door lock, and more particularly to a door lock for a home appliance.

### Discussion of Related Art

The door lock may be used to control the locking or unlocking of a door of a home appliance. The home appliances include a washing machine, a drying machine (dryer), a so-called washing-drying machine (i.e., an apparatus providing a combination of washing and drying functions to laundry), an oven, a microwave oven, and the like.

At present, a door of a home appliance (e.g., a washing machine) is securely locked to a front panel of the home appliance by means of a door lock. Such a door lock not only needs to realize a mechanical locking function under normal use conditions, but also needs to meet the electrical safety requirements under specific conditions. For example, when the door hook is pulled out of the door lock mechanism in a normal manner and the door is in an open state, the door lock should be able to synchronously cut off the power supply of the home appliance, ensuring personal safety during the operation of the user.

In addition, under some abnormal or extreme use conditions, for example, when the home appliance is running, a user may operate by mistake or apply an external force to forcibly open the door of the home appliance due to misfunction, and at this time, once key mechanical components (e.g., a door hook, a cam, a slider, or a lock latch) of the door lock is broken or separated due to overload, so that the door of the home appliance is abnormally opened, the door lock system still needs to have an instant response capability, and can rapidly and safely cut off the power supply, so that the running of the home appliance is immediately stopped to avoid potential risks such as personal injury, electrical short circuit, or mechanical damage.

In addition, for example, the door of the current home appliance such as the drum washing machine has two kinds of structures, namely a left side door opening structure and a right side door opening structure, and the current door lock is difficult to be matched with narrow installation spaces on the left side and the right side because of large transverse width, so that a door lock structure which has good versatility, is narrow in transverse width and can realize a door lock sensing function is required.

Therefore, there is still a need in the art for a door lock that combines mechanical locking reliability, versatility, and circuit power-off safety.

### SUMMARY OF THE INVENTION

In order to overcome the problems of reliability and circuit power-off safety possibly existing in the door lock in the prior art, the invention provides the door lock with a simple structure, high reliability and good versatility.

According to a first aspect of the present invention, there is provided a door lock comprising: a door lock box comprising a top cover, and the top cover is provided with a door lock hole for inserting a door hook; a cam arranged in the door lock box for catching the door hook; a slider located within the door lock box and slidable in an axial vertical direction between a locked position and an unlocked position; a switch box arranged at a rear portion of the door lock box, and the switch box includes an actuating latch for controlling a locking state of the slider; a sensing rocker provided with a forming part for interacting with the slider; a push rod positioned in the switch box for controlling the on-off of a door sensing circuit; wherein the sliding of the slider along the axial vertical direction causes the sensing rocker to rotate, and the rotation of the sensing rocker will cause the push rod to be switched between the first position and the second position.

In an embodiment of the first aspect of the present invention, the sensing rocker has a generally triangular configuration, and the switch box has a switch box cover, and the sensing rocker is pivotally connected at one end to the top cover or switch box cover.

In an embodiment of the first aspect of the present invention, the slider comprises an arc-shaped portion for contacting the forming part of the sensing rocker and driving the sensing rocker to rotate.

In an embodiment of the first aspect of the present invention, the sensing rocker further comprises an end piece at which the sensing rocker is spring loaded to tend to rotate the sensing rocker to switch the push rod from the first position to the second position.

In an embodiment of the first aspect of the present invention, the sensing rocker includes an inclined surface at the end piece that assists in pushing the push rod into the switch box.

In an embodiment of the first aspect of the present invention, the push rod comprises an arc portion at its top end, and the arc portion is preferably a dome portion.

In an embodiment of the first aspect of the present invention, the cam comprises a protrusion and the slider comprises a window corresponding to the door lock hole, and the window comprises a wall portion, and the protrusion abuts against the wall portion of the slider when the door lock is in an open position.

In an embodiment of the first aspect of the present invention, the slider is provided with a locking slot into which the actuating latch can extend, so as to lock the slider.

In an embodiment of the first aspect of the present invention, the door lock further comprises an unlocking lever for manual operation, which acts on a resilient contact piece in the switch box via a hook portion to open a main circuit and release the actuating latch.

In an embodiment of the first aspect of the present invention, the door lock box is provided with a snapping member for enabling screwless mounting of the door lock box to an external part.

In an embodiment of the first aspect of the present invention, the top cover is provided with a protrusion structure for limiting the maximum sliding distance of the slider.

In an embodiment of the first aspect of the present invention, the door hook pushes the cam to rotate after being inserted into the door lock hole, forms a mechanical interlock with the cam, and triggers the slider to move down to the locked position.

According to another aspect of the present invention, there is also provided a home appliance comprising the door lock according to the first aspect of the present invention.

The above summary is not intended to represent each embodiment, or every aspect, of the present disclosure. Rather, the foregoing summary merely provides an exemplification of some of the novel concepts and features set forth herein. The above features and advantages, and other features and attendant advantages of the present disclosure will be readily apparent from the following detailed description of the illustrative examples and representative modes for carrying out the present disclosure when taken in connection with the accompanying drawings and appended claims. Moreover, the present disclosure expressly encompasses any and all combinations and subcombinations of the elements and features as set forth above and below.

### BRIEF DESCRIPTION OF SEVERAL VIEWS OF THE DRAWINGS

The present disclosure will become more fully understood from the detailed description and the accompanying drawings.

FIG. 1 is a general structural schematic view of a door lock 1000 according to one embodiment of the present invention shown from the front thereof, and illustrates in exploded view some of the components of the door lock 1000;

FIG. 2 is a general structural schematic view of a door lock 1000 according to one embodiment of the invention shown from the opposite side thereof, and illustrates in exploded view some of the components of the door lock 1000;

FIG. 3 is a structural schematic view of a portion of a door lock 1000 according to an embodiment of the present invention, wherein the top cover 117 of the door lock 1000 of FIG. 1 is removed, with the door lock 1000 in an open position;

FIG. 4 is a structural schematic view of a portion of a door lock 1000 according to an embodiment of the present invention, wherein the top cover 117 and the slider 204 of the door lock 1000 of FIG. 1 are removed, with the door lock 1000 in an open position;

FIG. 5 is a cut-away perspective view of a portion of a door lock 1000 according to one embodiment of the invention shown from the opposite side thereof, wherein the relative positional relationships of the cam 201, slider 204, and actuating latch 103 are schematically illustrated when the door lock 1000 is in an open position;

FIG. 6 is a structural schematic view of a portion of a door lock 1000 according to one embodiment of the present invention, showing the cam 201, the slider 204, the sensing rocker 300, and the push rod 360 in an open position;

FIG. 7 is a structural schematic view of a portion of a door lock 1000 according to an embodiment of the present invention, wherein the top cover 117 of the door lock 1000 of FIG. 1 is removed, with the door lock 1000 in a closed position;

FIG. 8 is a cut-away perspective view of a portion of a door lock 1000 according to one embodiment of the invention shown from the opposite side thereof, wherein the relative positional relationships of the cam 201, the slider 204, and the actuating latch 103 are schematically illustrated when the door lock 1000 is in the closed position;

FIG. 9 is a structural schematic view of a portion of a door lock 1000 according to one embodiment of the present invention, showing the cam 201, the slider 204, the sensing rocker 300, and the push rod 360 in a closed position; and

FIG. 10 is a perspective view of a manual unlocking lever 400 of a door lock 1000 according to an embodiment of the present invention, and the manual unlocking lever 400 is used to manually unlock the door lock 1000 so that the door lock is in an open position.

In the different figures, like or same components are denoted by like or same reference numerals, and the figures are for illustrative purposes only and the components in the figures are not necessarily drawn to scale.

### DESCRIPTION OF PREFERRED EMBODIMENTS

The following description is merely exemplary in nature and is not intended to limit the present disclosure, application, or uses. The present disclosure is susceptible of embodiments in many forms. Representative examples of the present disclosure are illustrated in the accompanying drawings and will be described herein in detail. It should be understood that the present disclosure is to be considered as examples of the principles of the disclosure and is not intended to limit the broad aspect of the disclosure. Furthermore, the drawings are generally schematic and not necessarily drawn to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. In this regard, elements and limitations that are described, for example, in the abstract, background, brief summary, figures, and detailed description section, but not explicitly recited in the claims, should not be incorporated into the claims by implication, inference, or otherwise, either individually or collectively.

Certain terms may be used in the following description for reference purposes only and are therefore not intended to be limiting. For example, terms such as “above” and “below” refer to directions in the drawings to which reference is made. Terms such as “front”, “rear”, “in front”, “back”, “left”, “right”, “in rear”, “side”, “upward”, “downward”, “top” and “bottom” describe the orientations and/or positions of portions of a component or element within a consistent but arbitrary reference as made clear by reference to the text and the associated drawings describing the component or element as discussed.

Moreover, terms such as “first”, “second”, “third” and the like may be used to describe individual components. Such terms are used to describe the drawings and do not represent limitations on the scope of the disclosure, which is defined by the appended claims. Furthermore, the teachings may be described herein in terms of functional and/or logical block components and/or various processing steps.

For purposes of this detailed description, the singular includes the plural and vice versa, unless specifically stated otherwise; the words “and” and “or” shall be both conjunctions and disjunctions. The words “any” and “all” shall mean “any and all”. The words “including”, “comprising”, “having” and the like, shall mean “including, but not limited to”. Moreover, approximating language, such as “about”, “nearly”, “substantially”, “approximately”, “about”, etc., may each be used herein, for example, in the sense of “being at, near, or nearly at”, or “within 0%-5% of . . . . . . ”, or “within acceptable manufacturing tolerances”, or any logical combination thereof.

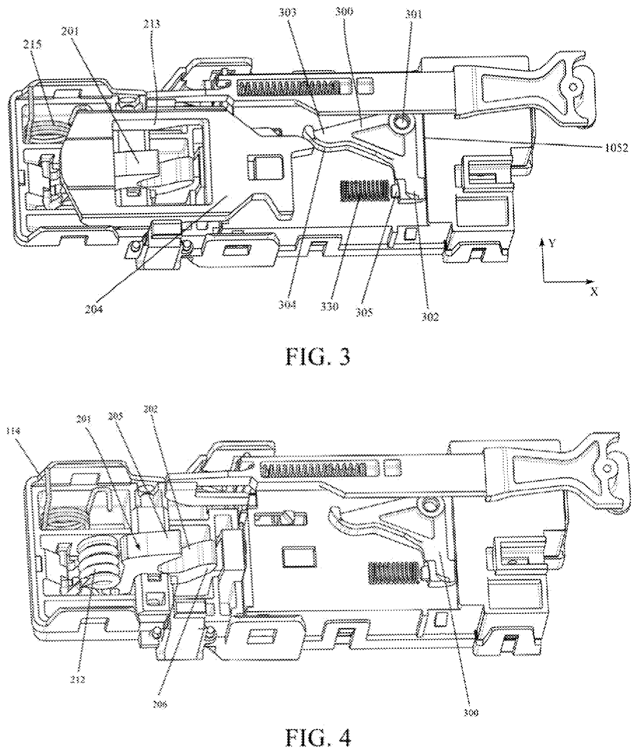

The present invention discloses a door lock, particularly a vertical type door lock, which has a compact structure and thus can be applied to most home appliances. The vertical door lock is shown as being generally horizontally disposed from the perspective of the some drawings, but it is to be understood that when describing the positional relationships or relative movements of the components within the door lock with respect to the door lock box, the left-right direction in the drawings may also be described as the up-down direction or vertical direction of the vertical door lock. For example, with reference to the schematic illustration in FIG. 3, the arrow X direction may be described as an axial vertical direction or an up-down direction, and the arrow Y direction may be described as a lateral direction or a width direction.

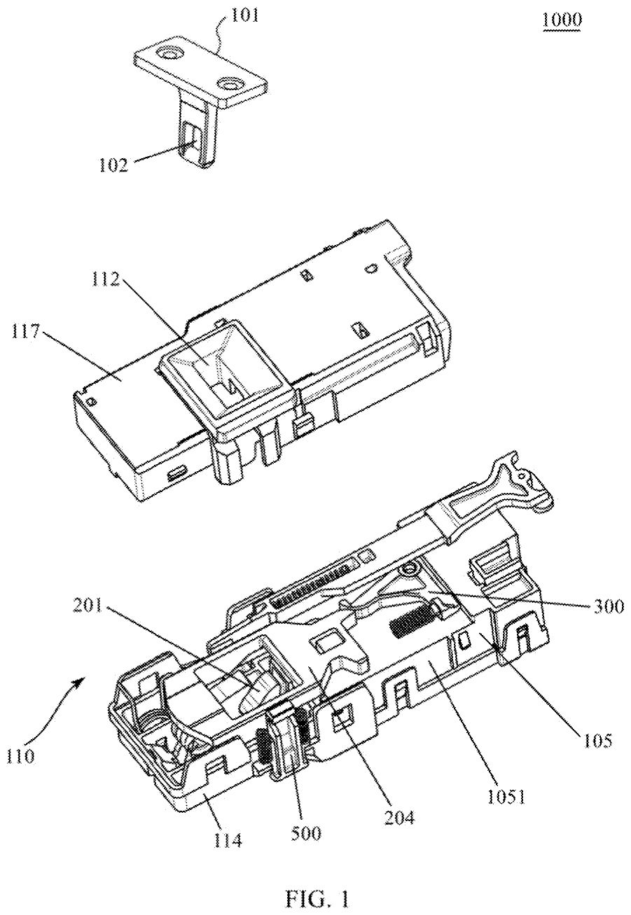

Referring now to the drawings, FIG. 1 is a general structural schematic view of a door lock 1000 according to one embodiment of the present invention shown from the front thereof, and illustrates in exploded view some of the components of the door lock 1000.

As shown in FIG. 1, the door lock 1000 includes a door lock box 110, and the door lock box 110 includes a top cover 117 and a base 114. A door lock hole 112 is formed in the upper surface of the top cover 117 on the head side, and the door lock hole 112 is configured to receive the door hook 101. The door hook 101 is located outside the door lock hole 112, engages with the cam 201 inside the door lock 1000 when the door hook 101 is inserted into the door lock 1000 from the door lock hole 112 on the door lock box 110. When the cam 201 is locked, the door of the home appliance is in a locked position, which position may also be referred to as a closed position of the door lock 1000.

As can be seen in FIG. 1, the door lock 1000 further comprises a switch box 105, a slider 204 (can also be called “main slider”, because the slider 204 is rather large compared with other components of the door lock) and a sensing rocker 300. The switch box 105 is installed under the tail side of the top cover 117. The function of the switch box 105 includes locking or unlocking the slider 204 and thus locking or unlocking the cam 201, and turning on or off a main circuit for controlling the door lock 1000.

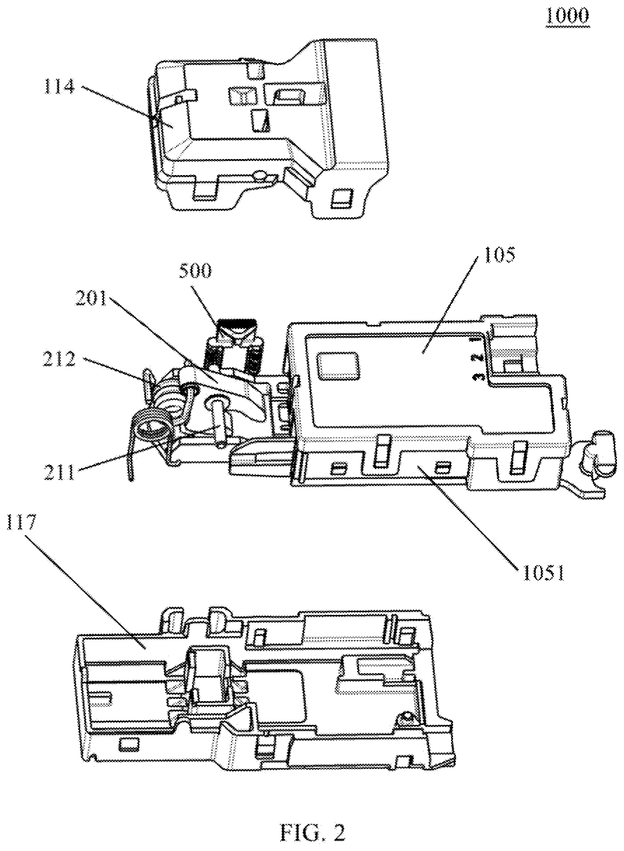

FIG. 2 is a general structural schematic view of a door lock 1000 according to one embodiment of the invention shown from the opposite side thereof, and illustrates in exploded view some of the components of the door lock 1000. As shown in FIGS. 1-2, a base 114 is provided opposite to the top cover 117 on the head side of the top cover 117, and a switch box 105 is provided under the tail side of the top cover 117. The base 114 constitutes a lower portion of the door lock box 110. The top cover 117 and the base 114 at least partially accommodate the switch box 105. The switch box 105 includes a switch box cover 1051 for accommodating the components of the switch box 105 therein.

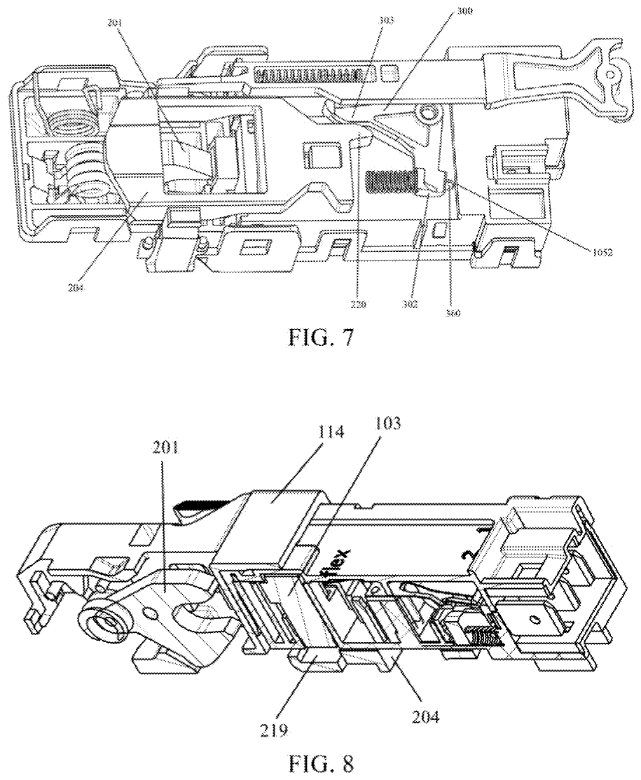

FIG. 3 is a structural schematic view of a portion of a door lock 1000 according to an embodiment of the present invention, wherein the top cover 117 of the door lock 1000 of FIG. 1 is removed, with the door lock 1000 in an open position. As shown in FIGS. 1 and 3, the slider 204 is disposed between the top cover 117 and the switch box 105, and extends across the base 114 and the switch box 105 in the height direction of the door lock box 110. The left end (upper end) of the slider 204 can cover a portion above the base 114. The slider 204 can slide up and down between the top cover 117 and the switch box cover 1051. In one embodiment of the invention, the slider 204 is movable between an unlocked position as shown in FIGS. 3-5, and a locked position as shown in FIGS. 7-8. In one embodiment of the present invention, the top cover 117 is provided with a protrusion structure (not shown) for limiting the maximum sliding distance of the slider 204.

As shown in FIG. 3, the door lock 1000 further includes a sensing rocker 300. In one embodiment of the present invention, the sensing rocker 300 maintains the push rod 360 in a retracted state in a non-sensing state, so as to keep the door sensing circuit open. In one embodiment of the present invention, the slider 204 drives the sensing rocker 300, such that the sliding of the slider 204 along the axial vertical direction causes the swinging motion or rotation of the sensing rocker 300, which causes the push rod 360 to switch between a first position and a second position. For example, in the first position, the push rod 360 extends out of the switch box 105. In the second position, the push rod 360 is pushed into the switch box by the sensing rocker 300. In one embodiment of the present invention, the sensing rocker 300 has a substantially triangular shape, in particular a substantially isosceles triangular shape. As shown in FIG. 3, the sensing rocker 300 is provided with a through hole 301, and the through hole 301 is located near one vertex at the base of the triangle, and the sensing rocker 300 is pivotably arranged on a pivot located on the switch box cover 1051 or the top cover 117 by means of the through hole 301. Near the other vertex of the sensing rocker 300 at the base of the triangle, a spring 330 is disposed, wherein one end of the spring 330 is fixed to the top cover 117, and the other end is located on the end piece 302 of the sensing rocker 300. In one embodiment, the end piece 302 is provided with an upwardly extending stub 305 and the other end of the spring 330 is nested on the stub 305. Since the spring 330 is compressed between the top cover 117 and the stub 305 of the sensing rocker 300, the spring 330 applies a downward force to the sensing rocker 300, especially to the end piece 302, tending to rotate the sensing rocker 300 counterclockwise until the end piece 302 abuts against a stop 1052 of the switch box cover 1051. The sensing rocker 300 further comprises a corresponding forming part 303 in the upper portion thereof. In one embodiment of the present invention, the corresponding forming part 303 comprises an arc-shaped section 304, and the arc-shaped section 304 is used for interacting with an arc-shaped part 221 of the slider 204, so that when the slider 204 moves downwards, the arc-shaped part 221 slides on the arc-shaped section 304, and simultaneously so that the sensing rocker 300 rotates clockwise against the spring force of the spring 330. In the present invention, the forming portion 220 and the corresponding forming part 303 are not limited to arc-shaped, as long as the slider 204 can transmit a force between the forming portion 220 and the corresponding forming part 303 and rotate the sensing rocker 300 clockwise when the slider 204 is moving downward.

FIG. 4 is a structural schematic view of a portion of a door lock 1000 according to an embodiment of the present invention, wherein the top cover 117 and the slider 204 of the door lock 1000 of FIG. 1 are removed, with the door lock 1000 in an open position. As shown in FIG. 4, a cam 201 is disposed on the base 114, and the cam 201 is disposed below a door hook 101. The main body of the cam 201 is, for example, a crescent-shaped curved structure, wherein the cam 201 is provided with an arc-shaped open slot 202, and an upper end of the open slot 202 is a hook-engaging portion 205, and the cam 201 is pushed to rotate after the door hook 101 is inserted into the door lock hole 112 (see FIG. 1), and the rotation of the cam 201 causes the hook-engaging portion 205 to be inserted into the hole 102 of the door hook 101 to catch the door hook 101. The lower end 206 of the open slot 202 contacts with the front end of the door hook 101, and when the door hook 101 is inserted, the front end of the door hook 101 abuts against the lower end 206 of the open slot 202, thereby pushing the cam 201 to rotate clockwise.

As shown in FIG. 2, the cam 201 is rotatably fixed to the base 114 by the rotating shafts 211 at both sides, so that the cam 201 can rotate around the rotating shafts 211. An elastic member 212 is mounted to the cam 201, and the elastic member 212 applies a biasing force to the cam 201 to promote or hinder the rotation of the cam 201. The elastic member 212 may be a torsion spring as shown in FIG. 2, in which one end of the spring is fixed to the cam 201, for example, inserted through a through hole of the cam 201, but the elastic member 212 may be another elastic member. It is the elastic member 212 which acts on the cam 201 to force the cam 201 to rotate back rapidly after it crosses a turning point under an external force (door-closing force) to generate an auxiliary door-pulling force, so that the hook-engaging portion 205 of the open slot 202 of the cam 201 catches the hole 102 of the door hook 101, thereby ensuring that the door is in the closed position or the locked position. When it is attempted to open the door, the elastic member 212 can generate certain resistance to prevent the washing machine door from being opened accidentally. Of course, the elastic member 212 is resilient in case that the cam is not locked (e.g. locked by the slider 204), allowing the door of the home appliance to be pushed away from the interior of the home appliance when required.

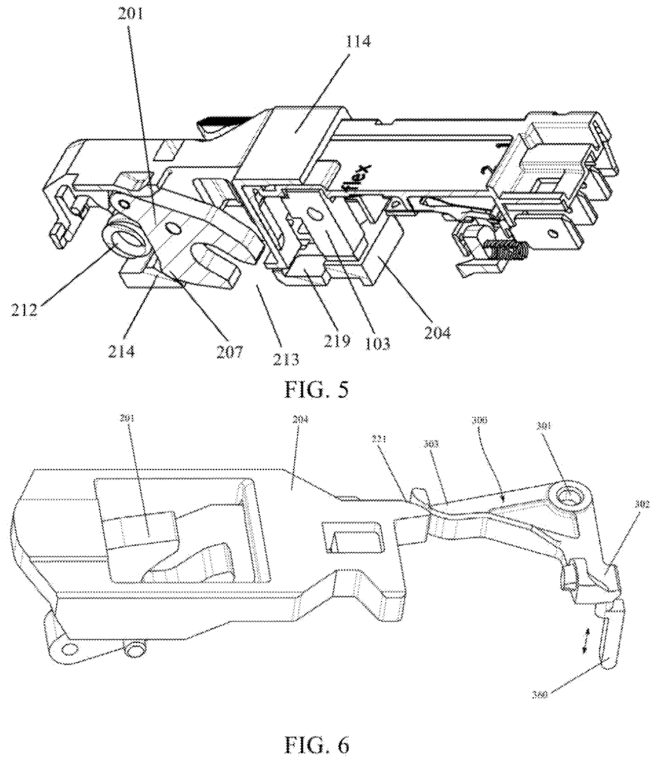

FIG. 5 is a cut-away perspective view of a portion of a door lock 1000 according to one embodiment of the invention shown from the opposite side thereof, wherein the relative positional relationships of the cam 201, slider 204, and actuating latch 103 are schematically illustrated when the door lock 1000 is in an open position. As shown in FIG. 3, another elastic member 215 for pushing the slider 204 to the right is provided, and the elastic member 215 may be a torsion spring as shown in FIG. 3, wherein one end of the spring is fixed to the slider 204. In one embodiment of the present invention, when the cam 201 is rotated from the open position shown in FIG. 5 to the closed position shown in FIG. 8, the slider 204 is pushed to the right by the elastic member 215. As shown in FIG. 5, the slider 204 is provided with a locking slot 219, when the slider 204 is in the locked position and an actuating latch 103 in the switch box 105 extends into the locking slot 219 (as shown in FIG. 8), the slider 204 is locked, and thus the door of the home appliance is also locked, and at this time the door of the home appliance is in the locked position and the door lock 1000 is in the closed position. The slider 204 is provided with a forming portion 220 at its lower end (see FIG. 7). In one embodiment of the present invention, the forming portion 220 includes an arc-shaped part 221, and the arc-shaped part 221 is used for rotating the sensing rocker 300, as will be described below. In one embodiment of the invention, the slider 204 includes a locking slot 219 on a lower surface thereof, and the locking slot 219 is used for receiving the actuating latch 103. When in the open position as shown in FIG. 5, the actuating latch 103 is not aligned with the locking slot 219 of the slider 204 and is abutted by the lower surface of the slider 204 and, therefore, the actuating latch 103 cannot extend into the locking slot 219.

As shown in FIG. 5, the cam 201 includes a protrusion 207. The slider 204 includes a window 213 (see FIG. 3) corresponding to the door lock hole 112 so as not to interfere with the engagement and disengagement of the door hook 101 with the cam 201. The window 213 comprises a wall portion 214 at the upper end. When the door lock 1000 is in the open position, the protrusion 207 abuts against the wall portion 214 of the slider 204 to help keep the slider 204 in the unlocked position and prevent the slider 204 from sliding toward the lock position due to action of the elastic member 215.

FIG. 6 is a structural schematic view of a portion of a door lock 1000 according to one embodiment of the present invention, showing the cam 201, the slider 204, the sensing rocker 300, and the push rod 360 in an open position. As shown in FIG. 6, the push rod 360 is located below the sensing rocker 300. The push rod 360 can move vertically up and down within the switch box 105. For example, when in the open position, the push rod 360 is pushed by the sensing rocker 300 to retract into the switch box 105, and in turn the push rod 360 turns off the door sensing circuit, which corresponds to a state in which the door of the home appliance can be opened.

FIG. 7 is a structural schematic view of a portion of a door lock 1000 according to an embodiment of the present invention, wherein the top cover 117 of the door lock 1000 of FIG. 1 is removed, with the door lock 1000 in a closed position. At this time, the slider 204 is located in a locked position at the lowest end. FIG. 8 is a cut-away perspective view of a portion of a door lock 1000 according to one embodiment of the invention shown from the opposite side thereof, wherein the relative positional relationships of the cam 201, the slider 204, and the actuating latch 103 are schematically illustrated when the door lock 1000 is in the closed position. With combined reference to FIGS. 3 and 7, when the slider 204 moves down toward the locked position at the lowermost end, the slider 204 causes the sensing rocker 300 to rotate clockwise by means of the interaction of its forming portion 220 with the corresponding forming part 303 of the sensing rocker 300. As the sensing rocker 300 rotates clockwise, the end piece 302 rotates clockwise away from the stop 1052 of the switch box cover 1051. At this time the end piece 302 no longer blocks the push rod 360, so the push rod 360 extends out from the switch box 105, for example due to a spring provided, whereby the door sensing circuit closes in response of the extending out of the push rod 360, so that after the switch box 105 receives this signal, the actuating latch 103 is electromagnetically actuated, and the actuating latch 103 protrudes into the locking slot 219 due to the electromagnetic actuation of the switch box 105, thereby locking the slider 204 in the locked position at the lowermost end. Due to the locking action of the slider 204, the door of the home appliance is locked in the closed state, preventing the door from being opened during the operation of the home appliance.

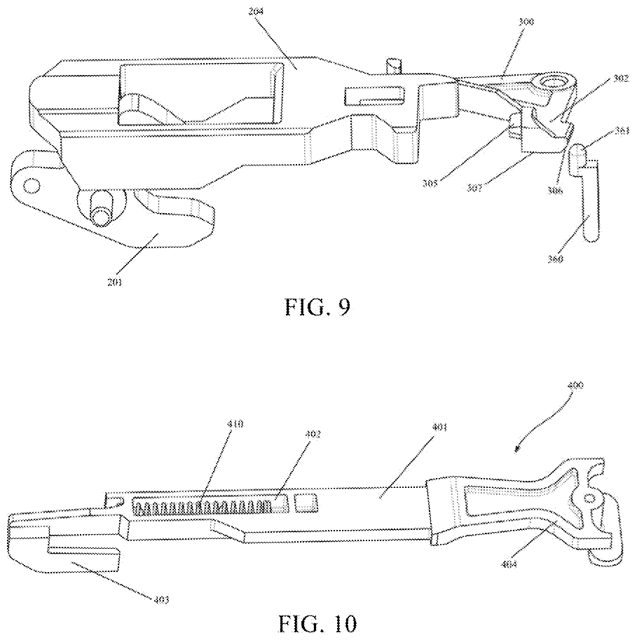

FIG. 9 is a structural schematic view of a portion of a door lock 1000 according to one embodiment of the present invention, showing the cam 201, the slider 204, the sensing rocker 300, and the push rod 360 in a closed position. In one embodiment of the present invention, the end piece 302 of the sensing rocker 300 comprises a bottom surface 307 and an inclined surface 306, and the inclined surface 306 extends from the bottom surface of the end piece 302 to the lower end of the end piece 302. That is, the inclined surface 306 of the end piece 302 is located on the portion of the end piece 302 facing away from the stub 305. In a preferred embodiment of the present invention, the push rod 360 includes an arc portion 361 at an upper end. In a preferred embodiment, the arc portion 361 is a dome portion 361, and the dome portion 361 facilitates being pressed and pushed by the sensing rocker 300. In a preferred embodiment of the present invention, the height of the push rod 360 extending out of the switch box 105 is less than or equal to the vertical height of the inclined surface 306. When the slider 204 moves upward from the locked position to the unlocked position, the sensing rocker 300 is no longer subjected to the acting force of the slider 204, and at this time, the sensing rocker 300 rotates counterclockwise due to the elastic force of the spring 330, and during the counterclockwise rotation, the inclined surface 306 presses the push rod 360, so that the push rod 360 is pushed back into the switch box 105 again. When the slider 204 is in the unlocked position, the flat bottom surface 307 of the end piece 302 blocks the push rod 360 to prevent the push rod 360 from protruding out from the switch box 105. When the push rod 360 is retracted into the switch box 105 due to being pushed by the sensing rocker 300 (particularly, the inclined surface 306 of the end piece 302), the push rod 360 opens the door sensing circuit, which corresponds to a state in which the door of the home appliance can be opened.

FIG. 10 is a perspective view of a manual unlocking lever 400 of a door lock 1000 according to an embodiment of the present invention, and the manual unlocking lever 400 is used to manually unlock the door lock 1000 so that the door lock is in an open position. In an embodiment of the present invention, the manual unlocking lever 400 has a pen-like structure, and includes a lever body 401 and a hook portion 403 extending in a detoured manner from the lever body 401. In one embodiment of the present invention, a groove 402 is arranged in the lever body 401, and the groove 402 is used for accommodating a spring 410. One end of the spring 410 abuts against the upper end of the groove 402, and the other end is fixed to the switch box cover 1051. The spring 410 is compressed to tend to push the manual unlocking lever 400 upward. A handle portion 404 is provided at the lower end of the lever body 401 to facilitate manual operation by an operator. The hook portion 403 is arranged to be able to press a resilient contact piece (not shown) in the switch box 105. When the operator pulls the manual unlocking lever 400 (especially the handle portion 404) downwards against the elasticity of the spring 410, the hook portion 403 can press the resilient contact piece in the switch box 105, so that the switch box 105 opens the main circuit for controlling the door lock 1000 and the actuating latch 103 moves away from the locking slot 219, so that the slider 204 can move upwards from the locked position to the unlocked position, and thus manual unlocking of the door of the home appliance is achieved.

In one embodiment of the present application, a locking or snapping member 500 is also shown in FIGS. 1-2. The locking member 500 is substantially saddle-shaped and at least partially form-fits with the top cover 117 and base 114. In one embodiment of the present application, the locking member 500 is movable in a vertical direction with respect to the top cover 117 and the base 114 between a first position in which the locking member 500 locks the door lock 1000 to the main body of the home appliance and a second position in which the locking member 500 releases the door lock 1000 from the main body of the home appliance, thereby enabling the door lock 1000 to be detached. That is, in the present application, by means of the locking member 500, a screwless or screwless design can be adopted to lock the door lock 1000 to the home appliance or an external part.

By adopting the door lock 1000 with the mechanical locking reliability, the versatility and the circuit power-off safety, the risks of potential personal injury, electrical short circuit or mechanical damage and the like are avoided, and the reliability of the door lock 1000 is improved, and the cost for a user is reduced.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited, because other modifications will become apparent upon a study of the drawings, the specification, and the following claims. For example, unless specifically stated otherwise, the size, shape, location or orientation of the various components may be changed as needed and/or desired, provided such changes do not substantially affect their intended functions. Unless otherwise specifically stated, components shown as directly connected or contacting each other may have intermediate structures disposed between them so long as the changes do not substantially affect their intended functions. The functions of one element may be performed by two elements, and vice versa, unless specifically stated otherwise. The structure and function in one embodiment may be adopted in another embodiment. Not all advantages must be present in a particular embodiment at the same time. Each feature which is unique from the prior art, alone or in combination with other features, also should be considered a separate description of further inventions by the applicant, including the structural and/or functional concepts embodied by such features. It should be understood that one or more steps within a method may be performed in a different order (or simultaneously) without altering the principles of the present disclosure. Moreover, although each of the embodiments is described above as having certain features, any one or more of those features described with reference to any embodiment of the disclosure may be implemented in and/or combined with the features of any of the other embodiments, even if the combination is not explicitly described. In other words, the described embodiments are not mutually exclusive and replacements and combinations of one or more embodiments with each other are still within the scope of the present disclosure.

1. A door lock comprising:
a door lock box comprising a top cover, and the top cover is provided with a door lock hole for inserting a door hook;
a cam arranged in the door lock box for catching the door hook;
a slider located within the door lock box and slidable in an axial vertical direction between a locked position and an unlocked position;
a switch box provided at a rear portion of the door lock box, and the switch box includes an actuating latch for controlling a locking state of the slider;
a sensing rocker provided with a forming part for interacting with the slider;
a push rod positioned in the switch box for controlling the on-off of a door sensing circuit;
wherein the sliding of the slider along the axial vertical direction causes the sensing rocker to rotate, and the rotation of the sensing rocker causes the push rod to be switched between the first position and the second position.

2. The door lock according to claim 1, wherein the sensing rocker has a generally triangular configuration, and the switch box has a switch box cover, and the sensing rocker is pivotally connected at one end to the top cover or switch box cover.

3. The door lock according to claim 1, wherein the slider comprises an arc-shaped portion for contacting the forming part of the sensing rocker and driving the sensing rocker to rotate.

4. The door lock according to claim 2, wherein the sensing rocker further comprises an end piece at which the sensing rocker is spring loaded to tend to rotate the sensing rocker to switch the push rod from the first position to the second position.

5. The door lock according to claim 4, wherein the sensing rocker includes an inclined surface at the end piece which assists in pushing the push rod into the switch box.

6. The door lock according to claim 1, wherein the push rod comprises an arc portion at its top end.

7. The door lock according to claim 1, wherein the cam comprises a protrusion and the slider comprises a window corresponding to the door lock hole, and the window comprises a wall portion, and the protrusion abuts against the wall portion of the slider when the door lock is in an open position.

8. The door lock according to claim 1, wherein the slider is provided with a locking slot into which the actuating latch can extend, so as to lock the slider.

9. The door lock according to claim 1, further comprising an unlocking lever for manual operation, and the unlocking lever acts on a resilient contact piece in the switch box via a hook portion thereof to open a main circuit and release the actuating latch.

10. The door lock according to claim 1, wherein the door lock box is provided with a snapping member for enabling screwless mounting of the door lock box to an external part.

11. The door lock according to claim 1, wherein the top cover is provided with a protrusion structure for limiting the maximum sliding distance of the slider.

12. The door lock according to claim 1, wherein the door hook pushes the cam to rotate after being inserted into the door lock hole, forms a mechanical interlock with the cam, and triggers the slider to move down to the locked position.

13. A home appliance comprising a door lock according to claim 1.
